(19) United States
(12) Patent Application Publication
(10) Pub. No.: US 2002/0198693 A1
(43) Pub. Date: Dec. 26, 2002

(54) Dady composite tetrahedral modeling element

(75) Inventor: Troy Marusich, Eden Prairie, MN (US)

Correspondence Address: Schwegman, Lundberg, Woessner & Kluth, P.A., P.O. Box 2938, Minneapolis, MN, 55402, US

(73) Assignee: Third Wave Systems, Inc.

(21) Appl. No.: 10/177,084

(22) Filed: Jun. 21, 2002

Related U.S. Application Data
(60) Provisional application No. 60/300,387, filed on Jun. 22, 2001.

(51) Int. Cl. G06F 17/10

(52) U.S. Cl. 703/2

(57) ABSTRACT

A modeling element and method of modeling deformation in a body is shown that reduces volumetric locking. Further, a modeling element and method has been shown that reduces computational complexity. The number of nodes per element is reduced, while still maintaining a reduction in constraints by utilizing a composite element. The modeling element is more amenable to adaptive meshing due to use of first-order elements. The modeling element includes a good aspect ratio in the parent element and sub-elements to improve accuracy and computational efficiency. Incorporating constant pressure on the parent element provides a more ideal constraint ratio.

### RELATED APPLICATION

This application claims the benefit of priority under 35 U.S.C. 119(e) to U.S. Provisional Patent Application Serial No. 60/300,387, filed Jun. 22, 2001, which is incorporated herein by reference in its entirety.

### TECHNICAL FIELD

The following disclosure relates to modeling of deformation in a body. Specifically, the following disclosure relates to three-dimensional modeling of deformation in a body using finite element analysis.

### BACKGROUND

Computational modeling of components or workpieces under stress is a particularly useful tool in engineering design. One use of computational modeling allows components to be tested in elastic deformation to withstand operating forces without breaking. Another use of computational modeling allows simulation of larger, plastic deformation. Plastic deformation modeling can be used to model materials during machining or forming a workpiece. It is beneficial to understand how workpiece materials plastically deform in order to design tooling such as cutting tools, tool dies etc. Computational modeling allows the user to simulate numerous potential design changes and test them for how the changes might affect the end product or manufacturing process. Avoiding the need to fabricate and test each potential design is a substantial savings in money and resources in the engineering process.

A common technique in computational modeling of components or workpieces is Finite Element Analysis (FEA). A digital representation of the component or workpiece to be modeled is first generated in an FEA environment such as a computer program. Software is then used to divide the component or workpiece into a mesh of small, discrete elements. The subdivision of the component or workpiece breaks the simulation problem down into a number of individual problems that can be solved using basic physics concepts. FEA allows the user to simulate larger, more complex behavior in components or workpieces by combining the results from each element solution of the mesh into an approximation of a global solution for the component or workpiece.

The configuration of the elements used to divide the component or workpiece determines many of the properties and accuracy of the model. In two dimensions, triangles or squares are often used. In three dimensions, tetrahedrons or cubes are often used. Further, element configurations include first-order elements and second-order elements.

A first-order element is defined as an element with first-order edges. A first-order edge is linear, and contains only two nodes at its endpoints. Linear edges are desirable because they produce linear contact pressure. Linear contact pressure better simulates actual materials in nature. A second-order element has second-order, or quadratic edges. Second order edges are allowed to curve in arcs or complex shapes. Second order edges are problematic in that they frequently do not produce linear contact pressure, allowing some nodes to exhibit zero pressure. Other possible edges include additional nodes between endpoints along an edge. Some multiple node edges do not curve as in a second-order edge, but they are allowed to “kink” and form multiple parts of an edge that are no longer collinear.

Several challenges exist as FEA techniques progress in the desire for more accurate and more efficient results. Volumetric locking is one common problem that challenges FEA modeling techniques today. Individual elements in an FEA model each have a fundamental number of constraints and a number of degrees of freedom. For example, in a four node, first-order, three dimensional tetrahedron, the minimum number of constraints is one. Volumetric locking occurs when the model is deformed to a condition where constraints are prohibiting movement in an element or a number of elements, and there are no degrees of freedom available to alleviate the condition. Volumetric locking therefore becomes a problem when for a given mesh, the number of constraints is too large in relation to the number of degrees of freedom.

One approach to reducing volumetric locking and retain linear contact pressure characteristics of an element has been to subdivide an element into a number of sub-elements. What is formed is a composite element that includes the parent element, and the sub-elements within the parent element. The element behavior properties of sub-elements within the parent element can be defined to allow a reduced integration of the mesh of elements. A reduced integration allows the sub-elements to share fundamental constraints, thus reducing the number of constraints per parent element while retaining degrees of freedom available for deformation. This technique allows the user to improve a constraint ratio for the parent element, even though the number of constraints is fixed for each sub-element when taken individually. The constraint ratio is defined as the number of degrees of freedom per element divided by the number of constraints per element. A desirable constraint ratio for three dimensional modeling is accepted in the industry as approximately three.

Composite elements have been introduced that include second-order parent elements, or elements with additional nodes between endpoints along an edge. However, curvature of second-order edges and “kinking” of multiple node edges during deformation makes a process called adaptive meshing difficult.

Adaptive meshing is commonly used in modeling situations where the elements, or a selected number of elements are inadequately sized to yield the desired modeling accuracy, or when the elements or a selected number of elements are deformed to an undesirable aspect ratio. Selected elements or regions of elements can be refined, or re-meshed with additional, smaller elements to provide more detail, or to provide new elements with a non-deformed aspect ratio. Alternatively, selected elements or regions of elements can be re-meshed or coarsened with fewer, larger elements to provide less detail and to reduce the computations needed in areas of less interest.

When second-order element edges become curved, or multiple node edges become “kinked,” the resulting parent element shape is difficult to fill by re-meshing. Further, second order edges and additional nodes add complexity to the deformation modeling process by adding integration computing time.

What is needed is a computational modeling element configured to reduce volumetric locking. What is also needed is a computational modeling element that reduces the computational complexity of elements with high numbers of nodes. What is also needed is a computational modeling element that can easily be used with adaptive meshing techniques.

### SUMMARY

The above mentioned problems with volumetric locking and computational complexity are addressed by the present invention and will be understood by reading and studying the following specification. Systems, devices and methods are provided for reducing volumetric locking. The systems, devices, and methods of the present invention further offer reduced computational complexity.

A computational modeling element is provided. The computational modeling element includes a first-order parent tetrahedron having four corner nodes at the corners of the tetrahedron; and an additional node that defines a number of sub-elements within the first-order tetrahedron. A method of modeling deformation in a body is also provided. The method includes generating a mesh of first-order tetrahedron elements that subdivide a representation of the body. The method includes configuring each first-order tetrahedron element to include an additional node that defines a number of sub-elements within the first-order tetrahedron. The method further includes defining a number of element behavior properties and calculating deformation data based on the element behavior properties. A machine-readable medium with instructions stored thereon is also provided. When executed, the instructions are operable to cause generation of a mesh of first-order tetrahedron elements that subdivide a representation of a body. The instructions are further operable to cause configuration of each first-order tetrahedron element to include an additional node that defines a number of sub-elements within the first-order tetrahedron element. The instructions are further operable to cause computation of deformation based on a number of element behavior properties for the first-order tetrahedron elements.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1A shows a body that has been subdivided into a number of elements.

FIG. 1B shows the a subdivided body after a simulated deformation.

FIG. 2 shows a modeling element.

FIG. 3 shows a flow diagram of one method for modeling deformation.

FIG. 4 shows another flow diagram of one method for modeling deformation.

FIG. 5 shows a block diagram of one operating environment in which embodiments of the invention may be practiced.

### DETAILED DESCRIPTION

In the following detailed description of the invention, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural changes, logical changes, etc. may be made without departing from the scope of the present invention.

In the following description, a body is defined to include components or workpieces etc. that are the object of a modeling simulation. Unless otherwise noted, references to a body will refer to an electronically generated representation of a body in contrast to an actual physical entity. Modeled simulations are subsequently performed on the representation of the body. Although a computer such as a desktop computer is contemplated as one embodiment of an environment where modeling calculations are performed, other virtual environments are within the scope of the invention.

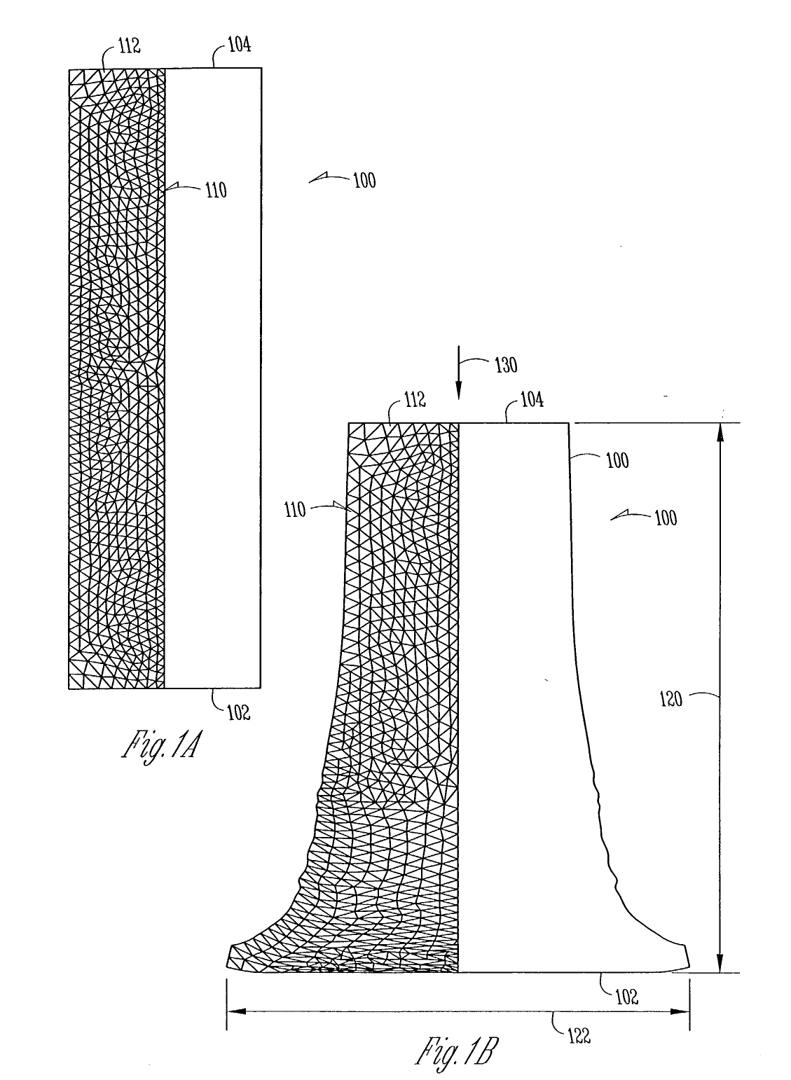

FIG. 1A show a body 100 with a first end 102 and a second end 104. The body 100 has been divided into a number of elements 112. The shape of the body 100 shown in FIG. 1A is substantially rectangular for ease of illustration. More complex shapes are typically of interest in FEA due to the difficulty of predicting their stress-strain behavior by other methods. Further, the body 100 is shown in two dimensions to illustrate meshing the body 100 into sub-elements. One skilled in the art, having the benefit of the present disclosure, will recognize that a three dimensional body can be similarly divided into a number of three dimensional elements.

The elements 112 shown in FIG. 1A form a mesh 110 that substantially fills the body 100. Each of the elements 112 of the mesh 110 are used to model deformation in the body 100. In one embodiment, the mesh 110 is a random oriented mesh as shown in FIG. 1A. In one embodiment, the mesh is a three dimensional mesh that substantially fills a three dimensional body. A random orientation mesh is a typical product of an automatic mesh generation program. In one embodiment, the mesh is generated by such an automatic mesh generation program. Although a random mesh 110 is shown, one skilled in the art, having the benefit of the present disclosure, will recognize that ordered meshes are also acceptable. In one embodiment, a three dimensional mesh is comprised of tetrahedrons. Tetrahedron meshes are a convenient configuration because they are frequently capable of generation with aforementioned automatic mesh generation programs. Although an automatic mesh generation program is a convenient method of sub dividing a body, other methods such as manual subdivision by the user, etc. are also acceptable.

FIG. 1B shows the body 100 after a modeled deformation. A stress has been simulated substantially along direction 130. As a result of the simulated stress, a height 120 of the body 100 has been strained in compression to a shorter height. Likewise, a width 122 of the body 100 has been strained to a wider width. The mesh 110 of elements 112 show selected elements with a high degree of distortion, while other elements show little distortion. For example, on average in FIG. 1B, elements 112 at the first end 102 are more highly distorted than elements 112 at the second end 104. As elements 112 become highly distorted, computations with respect to these elements becomes more difficult, and less accurate. A re-meshing or adaptive meshing technique to improve computational efficiency and model accuracy is discussed in more detail later in this disclosure. The representation of the body 100 in FIG. 1B is illustrative of one example of modeled strain. Final strained configurations will vary for different geometries of bodies and different material properties.

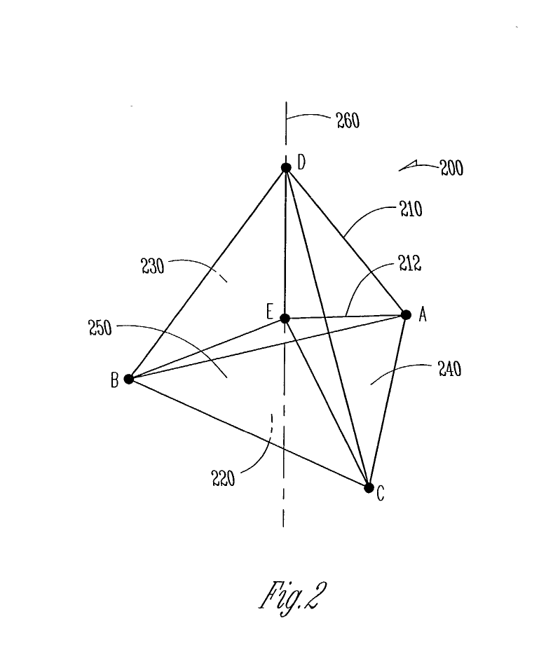

FIG. 2 shows one embodiment of a modeling element 200. The modeling element 200 is a tetrahedron modeling element that includes four primary nodes A, B, C, and D. The modeling element 200 further includes a number of primary edges 210. The primary edges 210 connect each of the primary nodes (A, B, C, and D) to define an outside surface of the modeling element 200. In the embodiment shown in FIG. 2, the primary edges are all first-order edges. As discussed above, first-order edges are linear, and include only the two end nodes that define a length of the primary edge. In one embodiment, six primary edges 210 form a tetrahedral modeling element 200 as shown in FIG. 2. Specifically, the primary edges shown in FIG. 2 can be defined by their respective end nodes. Primary edges AB, BC, AC, AD, CD, and BD form the modeling element 200. In one embodiment, all primary edges are the same length in an undistorted state of the modeling element 200.

In one embodiment, the modeling element 200 includes at least one secondary node. FIG. 2 shows a modeling element 200 with one secondary node E. In one embodiment, the secondary node E is located inside the volume of the modeling element 200 defined by the primary edges 210 and the primary nodes (A, B, C, and D). The secondary node E subdivides the modeling element 200 into a number of sub-elements. In one embodiment the secondary node subdivides the modeling element 200 into four sub-elements. The embodiment shown in FIG. 2 includes a first sub-element 220 defined by nodes ABCE; a second sub-element 230 defined by nodes ABDE; a third sub-element 240 defined by nodes ACDE; and a fourth sub-element 250 defined by nodes BCDE. In one embodiment, the sub-elements include tetrahedral sub-elements.

The modeling element 200 is defined as a composite element. The volume of the modeling element 200 defined by the primary edges 210 and the primary nodes (A, B, C, and D) is a parent element that includes sub-elements 220, 230, 240, and 250. As described above, one advantage of a composite element is that it can be configured to reduce the number of constraints in the parent element without reducing the number of degrees of freedom. In this way, the composite element configuration reduces volumetric locking.

The modeling element 200 includes a number of secondary edges 212 coupled to the secondary nodes. FIG. 2 shows four secondary edges 212 defined by nodes AE, BE, CE, and DE. In one embodiment, the secondary edges include first-order edges. In the embodiment shown in FIG. 2, the secondary edges 212 are all first-order edges. As defined above, first-order edges are linear, and include only the two end nodes that define a length of the edge. In one embodiment, the secondary edges are all the same length in an undistorted state of the modeling element 200. Secondary edges 212 are not to be confused with second-order edges as discussed in the background section above.

There are several advantages to embodiments of modeling elements as described above. The tetrahedron configuration of the parent element allows it to be used easily with automatic mesh generators. The tetrahedron configuration has a minimum number of sides, edges, and nodes thus making it a more simple, more fundamental building block for subdivision of a body. The reduced number of nodes simplifies computations during deformation modeling. The first-order edges are also more fundamental than second-order edges or edges with additional nodes between end nodes. First-order edges further reduce the computational complexity during deformation modeling. As noted above, the composite nature of the modeling elements described above allows the number of constraints to be reduced, while preserving the number of degrees of freedom. This allows a modeling element to be constructed with a more ideal constraint ratio. In one embodiment modeling element 200 has a constraint ratio of approximately 3.6.

As discussed above, during large deformations, selected elements can become severely distorted. A severely distorted element is undesirable because additional distortions on such elements require a large amount of computation, and because severely distorted elements produce a less accurate model of deformation in the body. Modeling elements as described above and shown in FIG. 2 include parent elements and sub-elements with relatively high aspect ratios.

An aspect ratio definition begins by taking a smallest possible sphere circumscribed about an element or sub-element where all corner nodes of the element or sub-element fall on the surface of the sphere. A second, largest possible sphere is then inscribed within the element or sub-element where no portion of the sphere falls outside the element or sub-element. The aspect ratio is then defined as the diameter of the circumscribed sphere divided by the diameter of the inscribed sphere.

An aspect ratio close to one is desirable because it can be distorted to a larger degree before it is considered to be severely distorted. In one embodiment, sub-elements of the composite element 200 are all similar in dimension and each have an aspect ratio of approximately 9.

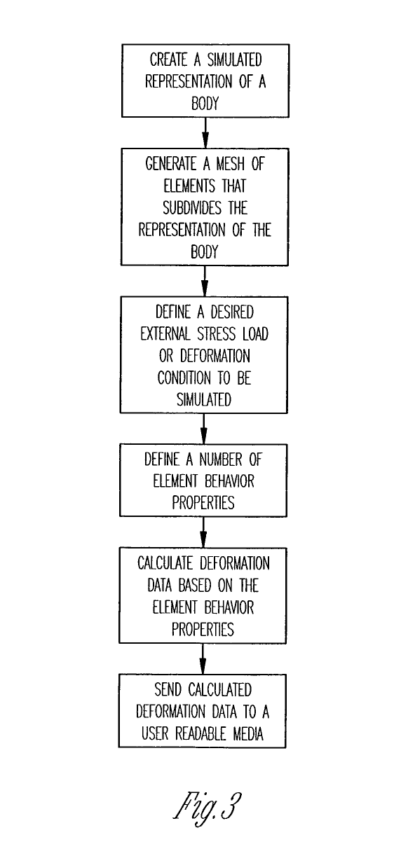

FIG. 3 shows one embodiment of a method for modeling deformation in a body. A representation of the body to be modeled is created in a simulation environment such as a computer. A mesh is generated within the body to subdivide the body into a number of elements. The elements used are composite elements as described in embodiments above. The desired deformation, or external force is entered, typically by a user. A number of element behavior properties are defined for the elements that will determine how the elements behave during the modeling process.

In one embodiment, element behavior properties include material properties such as bulk modulus of a material to be modeled. In one embodiment, element behavior properties include reduced integration techniques. In one embodiment, the parent element is defined to have constant pressure with all nodes of the composite element each having an average nodal pressure. In one embodiment, the parent element is defined to have constant pressure with sub elements each having an average pressure based on the constant parent element pressure. Using constant pressure, one embodiment of a modeling element as described above exhibits a constraint ratio of approximately 3.6. Embodiments that do not include constant pressure on the parent element exhibit constraint ratios in an approximate range of 1 to 2. As discussed above, a constraint ratio of approximately 3 is desired for three dimensional modeling. In an alternative embodiment, the parent element is defined to use average nodal pressure.

In one embodiment, the number of element behavior properties includes incorporating an hourglass mode control. Hourglass modes are defined as modes where due to the existing element behavior properties, a modeled deformation can exist where no energy is used to deform the body. This condition does not accurately reflect behavior of actual materials, therefore hourglass mode conditions are undesirable. Some approaches to hourglass mode controls include defining a stiffness or resistance to node movement at selected nodes of the modeling element.

After the element behavior properties and the desired loading conditions are defined, the deformation is calculated for the body by utilizing numerous integration steps as are known in the art. The resulting deformation data is then utilized in any of a number of ways. It can be stored, used for another iteration, sent to a user readable media, etc. One example of a user readable media includes a computer monitor such as a Cathode Ray Tube (CRT), a Liquid Crystal Display (LCD), etc.

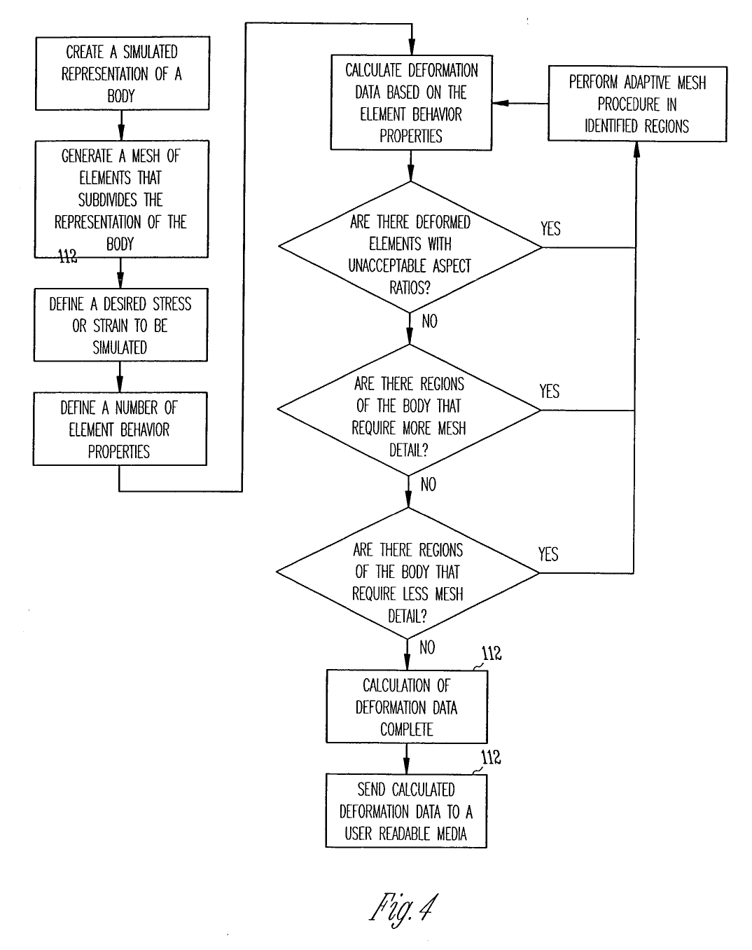

FIG. 4 shows another embodiment of a method for modeling deformation in a body. During calculation of the deformation data a process called adaptive meshing is used. Adaptive meshing is commonly used in modeling situations where the elements, or a selected number of elements are inadequately sized to yield the desired modeling accuracy, or when the elements or a selected number of elements are deformed to an undesirable aspect ratio. Selected elements or regions of elements can be refined, or re-meshed with additional, smaller elements to provide more detail, or to provide new elements with a non-deformed aspect ratio. Alternatively, selected elements or regions of elements can be re-meshed or coarsened with fewer, larger elements to provide less detail and to reduce the computations needed in areas of less interest. Fewer elements in low interest areas helps to increase modeling efficiency by focusing computational power on areas of interest in the body. Adaptive meshing further includes adding or removing elements in contrast to refining or coarsening the mesh. Adaptive meshing further includes improving elements by “flipping” a shared surface to improve aspect ratio. A shared surface between elements that are severely distorted can be flipped from an orientation where the surface is being expanded, to an orientation where the surface is being compressed, or vice versa. An adaptive meshing change in orientation of a shared surface does not affect overall volume or the number of elements in the mesh. It allows a number of adjacent elements to improve their aspect ratio. Deformation modeling, in one embodiment, includes a number of deformation calculation iterations with re-meshing performed after each iteration to focus computational accuracy on selected areas of interest, or areas with severely deformed elements.

The novel modeling element as described above is more efficient in use with adaptive meshing than elements such as second-order elements or elements with additional nodes between edge endpoints. Second-order edges and multiple node edges can deform or become curved to a more complex shape than a linear edged, first-order element. It becomes more difficult to re-mesh an element or region including a number of elements when the edges have become curved or kinked. The new elements in a re-meshed portion must be configured to fill the complex shapes that are formed when second-order edges are allowed to curve or multiple node edges are allowed to kink. In contrast, the novel modeling element as described above is first-order. Because the first-order edges do not curve or kink, a re-meshed region can be more easily refined, coarsened, etc. with novel composite elements during adaptive meshing.

In one embodiment, the novel modeling element includes axial symmetry about at least one axis of rotation. As can be seen in FIG. 2, the modeling element 200 is 3-fold axially symmetric about axis 260. In 3-fold axial symmetry, a modeling element can be rotated to three different positions about the axis of rotation to an identical orientation. Axial symmetry is an advantage because the modeling element 200 can be oriented about the axis of symmetry 260 without changing the behavior of the modeling element 200. For example, when the mesh of elements is generated in the body, the behavior of the elements in the mesh is less sensitive to orientation during mesh generation than non-symmetric elements. In one embodiment, the modeling element 200 includes multiple axes of symmetry. In one embodiment, the modeling element 200 includes four axes of symmetry.

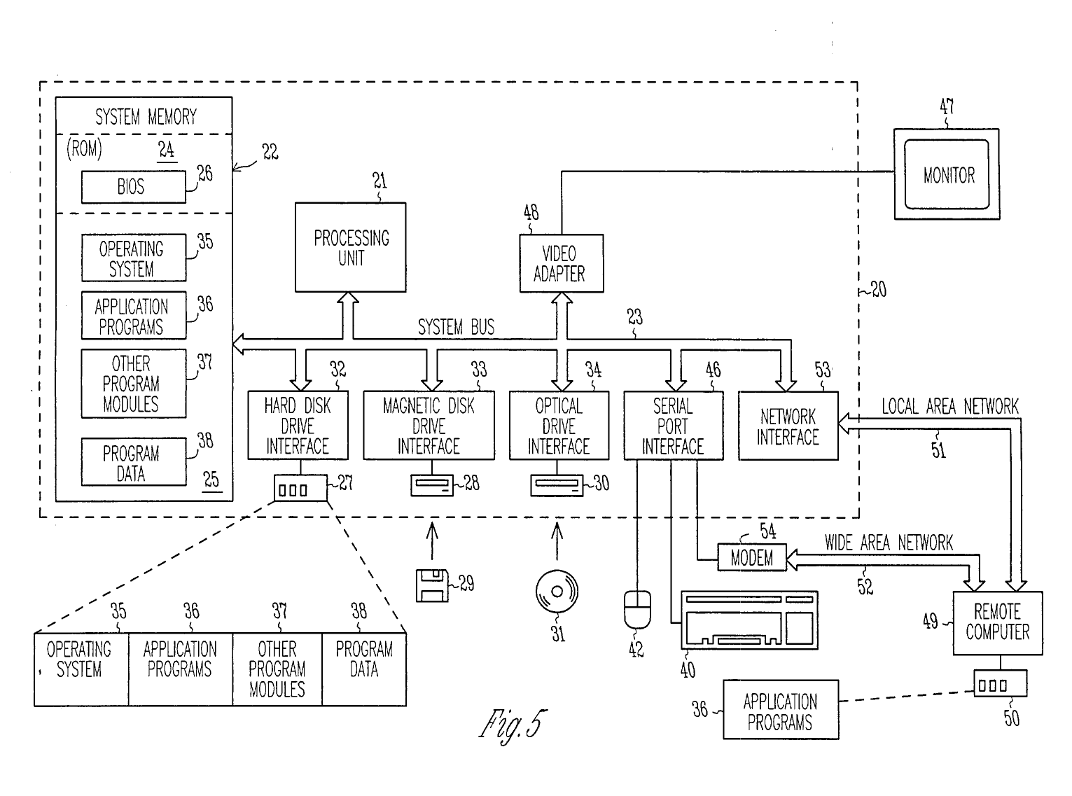

FIG. 5 provides a brief, general description of a suitable computing environment in which the above embodiments may be implemented. Embodiments of the invention will hereinafter be described in the general context of computer-executable program modules containing instructions executed by a personal computer (PC). Program modules include routines, programs, objects, components, data structures, etc. that perform particular tasks or implement particular abstract data types. Those skilled in the art will appreciate that the invention may be practiced with other computer-system configurations, including hand-held devices, multiprocessor systems, microprocessor-based programmable consumer electronics, network PCs, minicomputers, mainframe computers, and the like which have multimedia capabilities. The invention may also be practiced in distributed computing environments where tasks are performed by remote processing devices linked through a communications network. In a distributed computing environment, program modules may be located in both local and remote memory storage devices.

FIG. 5 shows a general-purpose computing device in the form of a conventional personal computer 20, which includes processing unit 21, system memory 22, and system bus 23 that couples the system memory and other system components to processing unit 21. System bus 23 may be any of several types, including a memory bus or memory controller, a peripheral bus, and a local bus, and may use any of a variety of bus structures. System memory 22 includes read-only memory (ROM) 24 and random-access memory (RAM) 25. A basic input/output system (BIOS) 26, stored in ROM 24, contains the basic routines that transfer information between components of personal computer 20. BIOS 26 also contains start-up routines for the system. Personal computer 20 further includes hard disk drive 27 for reading from and writing to a hard disk (not shown), magnetic disk drive 28 for reading from and writing to a removable magnetic disk 29, and optical disk drive 30 for reading from and writing to a removable optical disk 31 such as a CD-ROM or other optical medium. Hard disk drive 27, magnetic disk drive 28, and optical disk drive 30 are connected to system bus 23 by a hard-disk drive interface 32, a magnetic-disk drive interface 33, and an optical-drive interface 34, respectively. The drives and their associated computer-readable media provide nonvolatile storage of computer-readable instructions, data structures, program modules and other data for personal computer 20. Although the exemplary environment described herein employs a hard disk, a removable magnetic disk 29 and a removable optical disk 31, those skilled in the art will appreciate that other types of computer-readable media which can store data accessible by a computer may also be used in the exemplary operating environment. Such media may include magnetic cassettes, flash-memory cards, digital versatile disks, Bernoulli cartridges, RAMs, ROMs, and the like.

Program modules may be stored on the hard disk, magnetic disk 29, optical disk 31, ROM 24 and RAM 25. Program modules may include operating system 35, one or more application programs 36, other program modules 37, and program data 38. A user may enter commands and information into personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial-port interface 46 coupled to system bus 23; but they may be connected through other interfaces not shown in FIG. 5, such as a parallel port, a game port, or a universal serial bus (USB). A monitor 47 or other display device also connects to system bus 23 via an interface such as a video adapter 48. In addition to the monitor, personal computers typically include other peripheral output devices (not shown) such as speakers and printers. In one embodiment, one or more speakers 57 or other audio output transducers are driven by sound adapter 56 connected to system bus 23.

Personal computer 20 may operate in a networked environment using logical connections to one or more remote computers such as remote computer 49. Remote computer 49 may be another personal computer, a server, a router, a network PC, a peer device, or other common network node. It typically includes many or all of the components described above in connection with personal computer 20; however, only a storage device 50 is illustrated in FIG. 9. The logical connections depicted in FIG. 9 include local-area network (LAN) 51 and a wide-area network (WAN) 52. Such networking environments are commonplace in offices, enterprise-wide computer networks, intranets and the Internet.

When placed in a LAN networking environment, PC 20 connects to local network 51 through a network interface or adapter 53. When used in a WAN networking environment such as the Internet, PC 20 typically includes modem 54 or other means for establishing communications over network 52. Modem 54 may be internal or external to PC 20, and connects to system bus 23 via serial-port interface 46. In a networked environment, program modules, such as those comprising Microsoft® Word which are depicted as residing within 20 or portions thereof may be stored in remote storage device 50. Of course, the network connections shown are illustrative, and other means of establishing a communications link between the computers may be substituted.

Software may be designed using many different methods, including object oriented programming methods. C++ and Java are two examples of common object oriented computer programming languages that provide functionality associated with object oriented programming. Object oriented programming methods provide a means to encapsulate data members (variables) and member functions (methods) that operate on that data into a single entity called a class. Object oriented programming methods also provide a means to create new classes based on existing classes.

An object is an instance of a class. The data members of an object are attributes that are stored inside the computer memory, and the methods are executable computer code that act upon this data, along with potentially providing other services. The notion of an object is exploited in the present invention in that certain aspects of the invention are implemented as objects in one embodiment.

An interface is a group of related functions that are organized into a named unit. Each interface may be uniquely identified by some identifier. Interfaces have no instantiation, that is, an interface is a definition only without the executable code needed to implement the methods which are specified by the interface. An object may support an interface by providing executable code for the methods specified by the interface. The executable code supplied by the object must comply with the definitions specified by the interface. The object may also provide additional methods. Those skilled in the art will recognize that interfaces are not limited to use in or by an object oriented programming environment.

### Conclusion

Thus has been shown a modeling element and method of modeling deformation in a body that reduce volumetric locking. Further, a modeling element has been shown that reduces computational complexity. A small number of nodes are utilized, at the same time a reduction in constraints by utilizing a composite element is achieved. The modeling element is more amenable to adaptive meshing due to use of first-order elements. The modeling element includes a good aspect ratio in the parent element and sub-elements to improve accuracy and computational efficiency. Incorporating constant pressure on the parent element and average pressure on sub-elements provides a more ideal constraint ratio. The modeling element provides linear contact pressure due to the first-order nature of the modeling element.

Although specific embodiments have been illustrated and described herein, it will be appreciated by those of ordinary skill in the art, with the benefit of having read the present specification, that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A computational modeling element, comprising:
a first-order parent tetrahedron having four corner nodes at the corners of the tetrahedron; and
an additional node that defines a number of sub-elements within the first-order tetrahedron.

2. The computational modeling element of claim 1, wherein the additional node forms four first-order edges with each of the four corner nodes of the first-order tetrahedron.

3. The computational modeling element of claim 1, wherein the additional node defines four tetrahedral sub-elements within the first-order tetrahedron.

4. The computational modeling element of claim 1, wherein the first-order tetrahedron includes axial symmetry about at least one axis of rotation.

5. The computational modeling element of claim 4, wherein the first-order tetrahedron includes axial symmetry about four axes of rotation.

6. The computational modeling element of claim 1, wherein the sub-elements each include axial symmetry about at least one axis of rotation.

7. A method of modeling deformation in a body, comprising:
generating a mesh of first-order tetrahedron elements that subdivide a representation of the body;
configuring each first-order tetrahedron element to include an additional node that defines a number of sub-elements within the first-order tetrahedron;
defining a number of element behavior properties; and
calculating deformation data based on the element behavior properties.

8. The method of claim 7, wherein the deformation includes plastic deformation.

9. The method of claim 7, wherein configuring each first-order tetrahedron element to include an additional node includes configuring each first-order tetrahedron element to include an additional node that defines four tetrahedral sub-elements within each first-order tetrahedron element.

10. The method of claim 7, further including transferring the calculated deformation data to a user readable media.

11. The method of claim 7, further including adaptive meshing of selected regions within the body.

12. The method of claim 7, wherein defining a number of element behavior properties includes defining constant pressure for the first-order tetrahedron element with average sub-element pressure.

13. The method of claim 7, wherein defining a number of constraints includes:
utilizing a first pressure formulation for deformation below a critical strain; and
utilizing a second pressure formulation for deformations larger that the critical strain.

14. The method of claim 7, wherein defining a number of element behavior properties includes utilizing average nodal pressure.

15. The method of claim 7, wherein defining a number of element behavior properties includes defining an hourglass mode control.

16. The method of claim 7, wherein the steps are performed in the order presented.

17. A machine-readable medium with instructions stored thereon, the instructions when executed operable to cause:
generation of a mesh of first-order tetrahedron elements that subdivide a representation of a body;
configuration of each first-order tetrahedron element to include an additional node that defines a number of sub-elements within the first-order tetrahedron element;
computation of deformation based on a number of element behavior properties for the first-order tetrahedron elements.

18. The machine-readable medium of claim 17, wherein configuration of each first-order tetrahedron element to include an additional node includes configuration of each first-order tetrahedron element to include an additional node that defines four tetrahedral sub-elements within each first-order tetrahedron element.

19. The machine-readable medium of claim 17, wherein the number of element behavior properties for the first-order tetrahedrons includes constant pressure for each first-order tetrahedron element with average sub-element pressure.

20. The machine-readable medium of claim 17, wherein the number of element behavior properties for the first-order tetrahedrons includes average nodal pressure for each first-order tetrahedron element.
